(19) United States
(12) Patent Application Publication
(10) Pub. No.: US 2023/0307794 A1
(43) Pub. Date: Sep. 28, 2023

(54) SMART CONNECTION SHEET, BATTERY PACK, AND VEHICLE

(71) Applicant: BYD COMPANY LIMITED, Shenzhen (CN)

(72) Inventors: Zhe ZHAO, Shenzhen (CN); Naishu TAO, Shenzhen (CN); Qingbo PENG, Shenzhen (CN)

(21) Appl. No.: 18/319,888

(22) Filed: May 18, 2023

Related U.S. Application Data
(63) Continuation of application No. PCT/CN2021/119123, filed on Sep. 17, 2021.

(30) Foreign Application Priority Data
Nov. 20, 2020 (CN) 202011314702.9

(51) Int. Cl. H01M 50/503; H01M 50/583; H01M 50/51; H01M 50/581; H01M 10/42

(52) U.S. Cl. CPC H01M 50/503; H01M 10/425; H01M 50/51; H01M 50/581; H01M 50/583; H01M 2010/4271; H01M 2220/20

(57) ABSTRACT

A smart connection sheet includes a conductive connection member and a cut-off apparatus. An end of the conductive connection member is adapted to connect to a terminal of a battery core of a battery pack, and another end of the conductive connection member is adapted to connect to a terminal of an adj acent battery core of the battery pack, to implement a series connection between the two adjacent battery cores in the battery pack. When receiving a cut-off signal, the cut-off apparatus cuts off the conductive connection member, to disconnect the two battery cores connected to the conductive connection member.

### CROSS-REFERENCE TO RELATED APPLICATIONS

The present application is a continuation application of PCT application No. PCT/CN2021/119123 filed on Sep. 17, 2021, which claims priority to and benefits of Chinese Patent Application No. 202011314702.9 filed on Nov. 20, 2020, content of all of which is incorporated herein by reference in its entirety.

### FIELD

The present disclosure belongs to the technical field of new energy vehicles, and specifically, to a smart connection sheet, a battery pack, and a vehicle.

### BACKGROUND

The power source of an electric vehicle is mainly a battery pack (PACK). In a battery pack, multiple battery cores are connected in series to form a high-voltage circuit, so as to supply power to a motor of an electric vehicle. However, a safety risk exists in the battery pack formed by the battery cores connected in series. For example, phenomena such as a short-circuited battery pack may cause a risk of health damage and property losses. Therefore, safety protection needs to be provided for the battery pack.

In an existing safety protection solution for a battery pack, a safety device (a fuse) is mainly mounted in a high-voltage circuit of a battery pack. The safety device may be integrated into a safety device maintenance switch, and when the battery pack is short-circuited, the safety device fuses and breaks the high-voltage circuit of the battery pack to form voltage division.

However, the existing safety protection solution for a battery pack has the following defects:

(1). The safety device can fuse to break a short-circuit current and reduce a safety risk of battery pack voltage division only when the battery pack is short-circuited. In other safety accidents (such as violent collision, thermal runaway, overcharge, and the like), the safety device cannot automatically fuse.

(2). The safety device has a large size and occupies a large space. Because the mounting position is limited by space, the safety device usually can be mounted only in the safety device maintenance switch.

(3). When a local short circuit occurs, because the battery pack has a large quantity of strings of battery cores (currently, battery manufacturers have launched a solution in which hundreds of battery cores are connected in series), a voltage between any two terminals is still high (a direct current voltage over 60 V on a vehicle is determined as a high voltage, that is, a B-level voltage), and an electrical risk still exists.

### SUMMARY

In the existing safety protection solution using a safety device for a battery pack, the safety device often has a large size and occupies a large space. To solve this problem and/or other problems, a smart connection sheet, a battery pack, and a vehicle are provided.

According to an aspect, an embodiment of the present disclosure provides a smart connection sheet, including a conductive connection member and a cut-off apparatus. An end of the conductive connection member is connected to a terminal of a battery core of a battery pack, and another end of the conductive connection member is connected to a terminal of another adjacent battery core of the battery pack, to implement a series connection between the two adjacent battery cores in the battery pack. When receiving a cut-off signal, the cut-off apparatus cuts off the conductive connection member, to disconnect the two battery cores connected to the conductive connection member.

According to an embodiment of the present disclosure, the conductive connection member has a weakened area, and when receiving the cut-off signal, the cut-off apparatus cuts off the conductive connection member along the weakened area.

According to an embodiment of the present disclosure, the cut-off apparatus is electrically connected to a battery management system. The battery management system sends the cut-off signal to the cut-off apparatus when determining, through detecting a voltage, current, or temperature change signal of the battery pack, that a safety accident occurs to the battery pack. The safety accident includes one or more of violent collision, thermal runaway, a short circuit, or overcharge.

According to an embodiment of the present disclosure, the cut-off apparatus includes a driving apparatus and a punch. When receiving the cut-off signal, the cut-off apparatus drives, through the driving apparatus, the punch to move toward the conductive connection member, to cut off the conductive connection member through the punch.

According to an embodiment of the present disclosure, the cut-off apparatus further includes a housing, and the driving apparatus is a gas generator. The punch includes a cylindrical portion having an open end and a closed end, and a cutter head connected to the closed end of the cylindrical portion. The housing is internally provided with a guide hole, and the cylindrical portion is slidably arranged in the guide hole. The gas generator is accommodated in the cylindrical portion and is connected to an ignition power supply through a signal cable.

When ignited, gunpowder in the gas generator impacts on the punch, and the punch moves in an axial direction of the guide hole toward the conductive connection member, to cut off the conductive connection member through the cutter head.

According to an embodiment of the present disclosure, the housing is internally provided with a movement cavity that is in communication with an end of the guide hole close to the conductive connection member, and a conductive connection member accommodating cavity surrounding the movement cavity. The cutter head is located in the movement cavity, and the conductive connection member is inserted into the conductive connection member accommodating cavity.

The conductive connection member includes a first connection plate, a second connection plate, and an intermediate connection plate connected between the first connection plate and the second connection plate. The first connection plate and the second connection plate respectively extend out of the housing from two opposite sides. The first connection plate is connected to the terminal of one of the two battery cores, the second connection plate is connected to the terminal of the other battery core, and a to-be-cut-off part of the intermediate connection plate is located in the movement cavity.

In an initial state, the movement cavity is divided by the intermediate connection plate into a first cavity and a second cavity, and the cutter head is located in the first cavity. After the cutter head cuts off the conductive connection member, the second cavity accommodates a cut-off part of the conductive connection member.

According to an embodiment of the present disclosure, a part of the conductive connection member is thinned to form the weakened area; or a weakening score is provided on the conductive connection member to form the weakened area; or a part of the conductive connection member is made of a material with less strength than that of a peripheral part to form the weakened area.

The smart connection sheet according to this embodiment of the present disclosure includes a conductive connection member and a cut-off apparatus. An end of the conductive connection member is connected to a terminal of a battery core of a battery pack, and an other end of the conductive connection member is connected to a terminal of another adjacent battery core of the battery pack, to implement a series connection between the two adj acent battery cores in the battery pack. When receiving a cut-off signal, the cut-off apparatus cuts off the conductive connection member, to disconnect the two battery cores connected to the conductive connection member. In the present disclosure, the smart connection sheet can be used between some battery cores of the battery pack to replace a conventional metal connection sheet (the smart connection sheet and the conventional metal connection sheet have a small difference in size). The cut-off apparatus cuts off the conductive connection member of the smart connection sheet to break the high-voltage circuit of the battery pack, to provide safety protection for the battery pack. Compared with the safety device in the related art, the smart connection sheet has a smaller size, and can be placed between any two adj acent battery cores of the battery pack. The smart connection sheet has a flexible placing position, occupies a small space, and has a lower cost compared with the maintenance switch.

In addition, the battery management system (BMS) controls the cut-off apparatus to cut off the conductive connection member, to automatically cut off the high-voltage connection of the battery pack. In this way, the battery pack has a function of automatically protecting safety of the high-voltage circuit, thereby improving safety performance of the battery pack. Certainly, a controller independent of the battery management system may also be used to control the operation of the cut-off apparatus.

According to another aspect, an embodiment of the present disclosure provides a battery pack, including the foregoing smart connection sheet.

According to an embodiment of the present disclosure, multiple smart connection sheets are provided. When conductive connection members of the multiple smart connection sheets are cut off by cut-off apparatuses, a high-voltage circuit of the battery pack is divided into multiple sections of voltage division circuits, and a voltage of each section of voltage division circuit is below a safety voltage.

In this way, multiple smart connection sheets can be mounted in a pack body. When the conductive connection members of the multiple smart connection sheets are cut off by the cut-off apparatuses, the high-voltage circuit of the battery pack is divided into multiple sections of voltage division circuits, and the voltage of each section of voltage division circuit can be lowered below the safety voltage. For example, when two smart connection sheets are arranged in a battery pack, after the two smart connection sheets are cut off, a high-voltage circuit is changed into three sections of voltage division circuits, thereby implementing multi-section voltage division of the battery pack. Therefore, the voltage of the battery pack is controlled within a safety range, and the safety performance of the battery pack is improved.

According to still another aspect, an embodiment of the present disclosure provides a vehicle, including the foregoing smart connection sheet or the foregoing battery pack.

### BRIEF DESCRIPTION OF THE DRAWINGS

FIG. 1 is a schematic structural diagram of a battery pack according to an embodiment of the present disclosure.

FIG. 2 is a schematic electrical diagram of a battery pack according to an embodiment of the present disclosure.

FIG. 3 is a schematic diagram of an external structure of a smart connection sheet according to an embodiment of the present disclosure.

FIG. 4 is a schematic diagram of an internal structure of a smart connection sheet (in an initial state) according to an embodiment of the present disclosure.

FIG. 5 is a diagram of a working principle of a smart connection sheet according to an embodiment of the present disclosure.

The reference numerals in the specification are as follows:

1. battery core; 2. smart connection sheet; 21. conductive connection member; 211. first connection plate; 212. second connection plate; 213. intermediate connection plate; 214. weakened area; 22. cut-off apparatus; 221. punch; 2211. cylindrical portion; 2212. cutter head; 222. housing; 2221. guide hole; 2222. movement cavity; 22221. first cavity; 22222. second cavity; 2223. conductive connection member accommodating cavity; 223. gas generator; 224. signal cable; 3. metal connection sheet; 4. end plate; 5. side plate; and 6. battery management system.

### DETAILED DESCRIPTION

To make the technical problem resolved by the present disclosure, technical solutions, and advantageous effects clearer and more comprehensible, the following further describes the present disclosure in detail with reference to the accompanying drawings and embodiments. It should be understood that, the specific embodiments described herein are merely used for explaining the present disclosure instead of limiting the present disclosure.

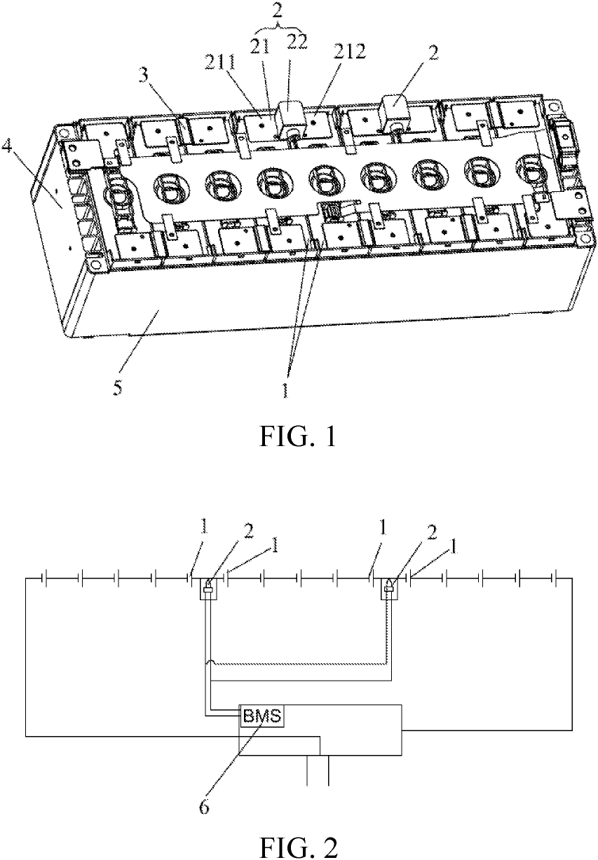

As shown in FIG. 1 and FIG. 2, a battery pack provided in an embodiment of the present disclosure includes multiple battery cores 1 connected in series and smart connection sheets 2.

In an embodiment, the smart connection sheet 2 includes a conductive connection member 21 and a cut-off apparatus 22. An end of the conductive connection member 21 is connected to a terminal of a battery core 1 of the battery pack, and an other end of the conductive connection member 21 is connected to a terminal of another adjacent battery core 1 of the battery pack, to implement a series connection between the two adjacent battery cores 1 in the battery pack.

As shown in FIG. 1, the multiple battery cores 1 are stacked in a width direction thereof to form a battery stack. Two sides of the battery stack in a length direction are provided with end plates 4, and two sides of the battery stack in a width direction are provided with side plates 5. In the multiple battery cores 1, some are connected in series through the smart connection sheets 2, and the remaining are connected in series through conventional metal connection sheets 3.

When receiving a cut-off signal, the cut-off apparatus 22 cuts off the conductive connection member 21, to disconnect the two battery cores 1 connected to the conductive connection member 21. The conductive connection member 21 is a metal plate or another conductive object.

In an embodiment, the cut-off apparatus 22 is electrically connected to a battery management system (BMS) 6. The battery management system 6 sends the cut-off signal to the cut-off apparatus 22 when determining, through detecting a voltage, current, or temperature change signal of the battery pack, that a safety accident occurs to the battery pack. The safety accident includes one or more of violent collision, thermal runaway, a short circuit, or overcharge. For example, when a temperature rising rate of a monitored point in the battery pack dT/dt≥1° C./s (specific data may change according to a control policy), and lasts for over 3 s, it may be considered that thermal runaway occurs to the battery pack. For another example, when a circuit current of the battery pack far exceeds a rated current, it may be considered that the battery pack is short-circuited.

The battery management system 6 may detect a voltage signal of the battery pack through a battery information collector (BIC). The battery management system 6 may detect a temperature signal of the battery pack through a negative temperature coefficient (NTC) thermistor, and may detect a current signal through a Hall sensor.

In an embodiment, the cut-off apparatus 22 includes a driving apparatus and a punch 221. When receiving the cut-off signal, the cut-off apparatus 22 drives, through the driving apparatus, the punch 221 to move toward the conductive connection member 21, to cut off the conductive connection member 21 through the punch 221.

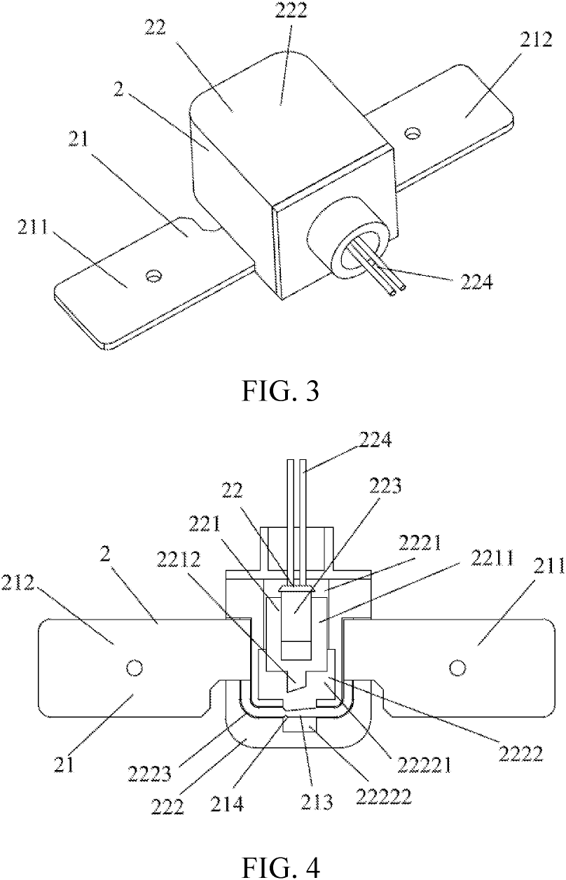

In an embodiment, as shown in FIG. 3 and FIG. 4, the cut-off apparatus 22 further includes a housing 222. The driving apparatus is a gas generator 223 and the gas generator 223 includes a gunpowder storehouse and gunpowder stored in the gunpowder storehouse. The punch 221 includes a cylindrical portion 2211 having an open end and a closed end, and a cutter head 2212 connected to the closed end of the cylindrical portion 2211. The housing 222 is internally provided with a guide hole 2221, and the cylindrical portion 2211 is slidably arranged in the guide hole 2221. The gas generator 223 is accommodated in the cylindrical portion 2211 and is connected to an ignition power supply through a signal cable 224. When ignited, the gunpowder in the gas generator 223 impacts on the punch 221, and the punch 221 moves in an axial direction of the guide hole 2221 toward the conductive connection member 21, to cut off the conductive connection member 21 through the cutter head 2212.

In an embodiment, the housing 222 is internally provided with a movement cavity 2222 that is in communication with an end of the guide hole 2221 close to the conductive connection member 21, and a conductive connection member accommodating cavity 2223 surrounding the movement cavity 2222. The cutter head 2212 is located in the movement cavity 2222, and the conductive connection member 21 is inserted into the conductive connection member accommodating cavity 2223.

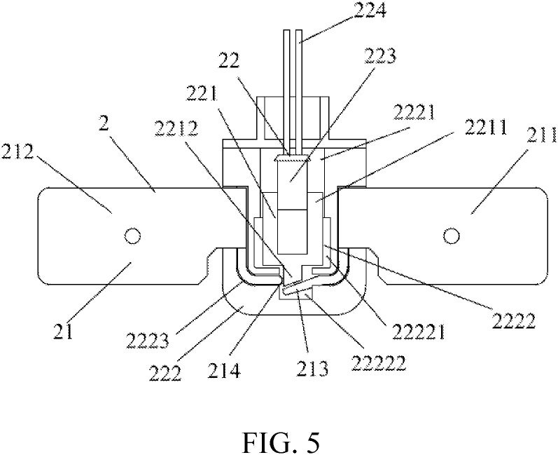

In an embodiment, as shown in FIG. 1, FIG. 3, and FIG. 4, the conductive connection member 21 includes a first connection plate 211, a second connection plate 212, and an intermediate connection plate 213 connected between the first connection plate 211 and the second connection plate 212. The first connection plate 211 and the second connection plate 212 respectively extend out of the housing 222 from two opposite sides. The first connection plate 211 is connected to the terminal of one of the two battery cores 1, the second connection plate 212 is connected to the terminal of the other battery core 1, and a to-be-cut-off part of the intermediate connection plate 213 is located in the movement cavity 2222. Referring to FIG. 5, in an initial state, the movement cavity 2222 is divided by the intermediate connection plate 213 into a first cavity 22221 and a second cavity 22222, and the cutter head 2212 is located in the first cavity 22221. After the cutter head 2212 cuts off the conductive connection member 21, the second cavity 22222 can accommodate a cut-off part (the intermediate connection plate 213) of the conductive connection member 21 and avoid the cutter head 2212.

Referring to FIG. 1, the first connection plate 211 covers a top surface of the one of the two battery cores 1, and the second connection plate 212 covers a top surface of the other battery core 1. The first connection plate 211 and the second connection plate 212 are connected to the terminals of the battery cores 1 by welding. Optionally, the first connection plate 211 and the second connection plate 212 are provided with a welding hole for being connected to the terminals by welding.

In an embodiment, the conductive connection member 21 has a weakened area 214, and when receiving the cut-off signal, the cut-off apparatus 22 cuts off the conductive connection member 21 along the weakened area 214.

In an embodiment, referring to FIG. 4, a part (the intermediate connection plate 213) of the conductive connection member 21 is thinned to form the weakened area 214.

However, alternatively, a weakening score may also be provided on the conductive connection member to form the weakened area; or a part of the conductive connection member is made of a material with less strength than that of a peripheral part to form the weakened area.

In an optional embodiment, multiple smart connection sheets 2 are provided. When conductive connection members 21 of the multiple smart connection sheets 2 are cut off by cut-off apparatuses 22, a high-voltage circuit of the battery pack is divided into multiple sections of voltage division circuits, and a voltage of each section of voltage division circuit is below a safety voltage. In this way, multiple smart connection sheets 2 can be mounted in a pack body. When the conductive connection members 21 of the multiple smart connection sheets 2 are cut off by the cut-off apparatuses 22, the high-voltage circuit of the battery pack is divided into multiple sections of voltage division circuits, and the voltage of each section of voltage division circuit can be lowered below the safety voltage. For example, referring to FIG. 2, when two smart connection sheets 2 are arranged in a battery pack, after the two smart connection sheets 2 are cut off, a high-voltage circuit is changed into three sections of voltage division circuits, thereby implementing multi-section voltage division of the battery pack. Therefore, the voltage of the battery pack is controlled within a safety range, and the safety performance of the battery pack is improved.

Referring to FIG. 4 and FIG. 5, a working principle of the smart connection sheet of this embodiment of the present disclosure is as follows:

When the battery management system 6 determines that a safety accident (violent collision, thermal runaway, a short circuit, or overcharge) occurs to the battery pack, the battery management system 6 sends, to the cut-off apparatus 22 (the gas generator 223), a cut-off signal (usually a voltage signal) for cutting off the conductive connection member 21 of the smart connection sheet 2 and triggers a current to ignite the gunpowder in the gas generator 223 through the signal cable. Gunpowder explosion provides thrust for the punch 221, and the punch 221 is thrust toward a weak area (the weakened area 214) of the conductive connection member 21 under the impact of gunpowder explosion. The cutter head 2212 cuts off the conductive connection member 21 along the weakened area 214, and the conductive connection member 21 is cut off from the middle. The high-voltage circuit of the battery pack formed through connection by the conductive connection member 21 is broken at the conductive connection member 21, to form voltage division.

The smart connection sheet and the battery pack according to this embodiment of the present disclosure includes a conductive connection member and a cut-off apparatus. An end of the conductive connection member is connected to a terminal of a battery core of a battery pack, and an other end of the conductive connection member is connected to a terminal of another adjacent battery core of the battery pack, to implement a series connection between the two adjacent battery cores in the battery pack. When receiving a cut-off signal, the cut-off apparatus cuts off the conductive connection member, to disconnect the two battery cores connected to the conductive connection member. In the present disclosure, the smart connection sheet can be used between some battery cores of the battery pack to replace a conventional metal connection sheet (referring to FIG. 1, the smart connection sheet and the conventional metal connection sheet have a small difference in size). The cut-off apparatus cuts off the conductive connection member of the smart connection sheet to break the high-voltage circuit of the battery pack, to provide safety protection for the battery pack. Compared with the safety device in the related art, the smart connection sheet has a smaller size, and can be placed between any two adjacent battery cores of the battery pack. The smart connection sheet has a flexible placing position, occupies a small space, and has a lower cost compared with the maintenance switch.

In addition, the battery management system (BMS) controls the cut-off apparatus to cut off the conductive connection member, to automatically cut off the high-voltage connection of the battery pack. In this way, the battery pack has a function of automatically protecting safety of the high-voltage circuit, thereby improving safety performance of the battery pack. Certainly, a controller independent of the battery management system may also be used to control the operation of the cut-off apparatus.

In another embodiment, the driving apparatus of the cut-off apparatus may also be replaced with a servo electric cylinder, a hydraulic cylinder, a pneumatic cylinder, or the like.

In addition, an embodiment of the present disclosure provides a vehicle, including the smart connection sheet 2 in the foregoing embodiment or the battery pack in the foregoing embodiment.

The foregoing descriptions are merely preferred embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A smart connection sheet, comprising:
a conductive connection member and a cut-off apparatus, wherein
an end of the conductive connection member is adapted to connect to a terminal of a battery core of a battery pack, and another end of the conductive connection member is adapted to connect to a terminal of an adjacent battery core of the battery pack, to implement a series connection between the two adjacent battery cores in the battery pack; and
when receiving a cut-off signal, the cut-off apparatus cuts off the conductive connection member, to disconnect the two battery cores connected to the conductive connection member.

2. The smart connection sheet according to claim 1, wherein the conductive connection member has a weakened area, and when receiving the cut-off signal, the cut-off apparatus cuts off the conductive connection member along the weakened area.

3. The smart connection sheet according to claim 1, wherein the cut-off apparatus is configured to be electrically connected to a battery management system, and the battery management system sends the cut-off signal to the cut-off apparatus when determining, through detecting a voltage, current, or temperature change signal of the battery pack, that a safety accident occurs to the battery pack; and the safety accident comprises one or more of violent collision, thermal runaway, a short circuit, or overcharge.

4. The smart connection sheet according to claim 1, wherein the cut-off apparatus comprises a driving apparatus and a punch, and when receiving the cut-off signal, the cut-off apparatus drives, through the driving apparatus, the punch to move toward the conductive connection member, to cut off the conductive connection member through the punch.

5. The smart connection sheet according to claim 4, wherein the cut-off apparatus further comprises a housing, and the driving apparatus is a gas generator; the punch comprises a cylindrical portion having an open end and a closed end, and a cutter head connected to the closed end of the cylindrical portion, the housing is internally provided with a guide hole, the cylindrical portion is slidably arranged in the guide hole, and the gas generator is accommodated in the cylindrical portion and is connected to an ignition power supply through a signal cable; and
when ignited, gunpowder in the gas generator impacts on the punch, and the punch moves in an axial direction of the guide hole toward the conductive connection member, to cut off the conductive connection member through the cutter head.

6. The smart connection sheet according to claim 5, wherein the housing is internally provided with a movement cavity that is in communication with an end of the guide hole close to the conductive connection member, and a conductive connection member accommodating cavity surrounding the movement cavity, the cutter head is located in the movement cavity, and the conductive connection member is inserted into the conductive connection member accommodating cavity;
the conductive connection member comprises a first connection plate, a second connection plate, and an intermediate connection plate connected between the first connection plate and the second connection plate, the first connection plate and the second connection plate respectively extend out of the housing from two opposite sides, the first connection plate is configured to connect to the terminal of one of the two battery cores, the second connection plate is configured to connect to the terminal of the other battery core, and a to-be-cut-off part of the intermediate connection plate is located in the movement cavity;
in an initial state, the movement cavity is divided by the intermediate connection plate into a first cavity and a second cavity, and the cutter head is located in the first cavity; and after the cutter head cuts off the conductive connection member, the second cavity accommodates a cut-off part of the conductive connection member.

7. The smart connection sheet according to claim 2, wherein the weakened area is a thinned part of the conductive connection member; or
the weakened area is an area of the conductive connection member surrounded by a weakening score; or
the weakened area is a part of the conductive connection member made of a material with less strength than that of a peripheral part.

8. A battery pack, comprising a smart connection sheet comprising:
a conductive connection member and a cut-off apparatus, wherein
an end of the conductive connection member is adapted to connect to a terminal of a battery core of a battery pack, and another end of the conductive connection member is adapted to connect to a terminal of an adjacent battery core of the battery pack, to implement a series connection between the two adjacent battery cores in the battery pack; and
when receiving a cut-off signal, the cut-off apparatus cuts off the conductive connection member, to disconnect the two battery cores connected to the conductive connection member.

9. The battery pack according to claim 8, wherein the battery pack comprises a plurality of smart connection sheets, when conductive connection members of the plurality of smart connection sheets are cut off by cut-off apparatuses, a high-voltage circuit of the battery pack is divided into a plurality of sections of voltage division circuits, and a voltage of each section of voltage division circuit is below a safety voltage.

10. The battery pack according to claim 8, wherein the conductive connection member has a weakened area, and when receiving the cut-off signal, the cut-off apparatus cuts off the conductive connection member along the weakened area.

11. The battery pack according to claim 8, wherein the cut-off apparatus is configured to be electrically connected to a battery management system, and the battery management system sends the cut-off signal to the cut-off apparatus when determining, through detecting a voltage, current, or temperature change signal of the battery pack, that a safety accident occurs to the battery pack; and the safety accident comprises one or more of violent collision, thermal runaway, a short circuit, or overcharge.

12. The battery pack according to claim 8, wherein the cut-off apparatus comprises a driving apparatus and a punch, and when receiving the cut-off signal, the cut-off apparatus drives, through the driving apparatus, the punch to move toward the conductive connection member, to cut off the conductive connection member through the punch.

13. The battery pack according to claim 12, wherein the cut-off apparatus further comprises a housing, and the driving apparatus is a gas generator; the punch comprises a cylindrical portion having an open end and a closed end, and a cutter head connected to the closed end of the cylindrical portion, the housing is internally provided with a guide hole, the cylindrical portion is slidably arranged in the guide hole, and the gas generator is accommodated in the cylindrical portion and is connected to an ignition power supply through a signal cable; and
when ignited, gunpowder in the gas generator impacts on the punch, and the punch moves in an axial direction of the guide hole toward the conductive connection member, to cut off the conductive connection member through the cutter head.

14. The battery pack according to claim 13, wherein the housing is internally provided with a movement cavity that is in communication with an end of the guide hole close to the conductive connection member, and a conductive connection member accommodating cavity surrounding the movement cavity, the cutter head is located in the movement cavity, and the conductive connection member is inserted into the conductive connection member accommodating cavity;
the conductive connection member comprises a first connection plate, a second connection plate, and an intermediate connection plate connected between the first connection plate and the second connection plate, the first connection plate and the second connection plate respectively extend out of the housing from two opposite sides, the first connection plate is configured to connect to the terminal of one of the two battery cores, the second connection plate is configured to connect to the terminal of the other battery core, and a to-be-cut-off part of the intermediate connection plate is located in the movement cavity;
in an initial state, the movement cavity is divided by the intermediate connection plate into a first cavity and a second cavity, and the cutter head is located in the first cavity; and after the cutter head cuts off the conductive connection member, the second cavity accommodates a cut-off part of the conductive connection member.

15. The battery pack according to claim 10, wherein the weakened area is a thinned part of the conductive connection member; or
the weakened area is an area of the conductive connection member surrounded by a weakening score; or
the weakened area is a part of the conductive connection member made of a material with less strength than that of a peripheral part.

16. A vehicle, comprising a battery pack, the battery pack comprises a smart connection sheet comprising:
a conductive connection member and a cut-off apparatus, wherein
an end of the conductive connection member is adapted to connect to a terminal of a battery core of a battery pack, and another end of the conductive connection member is adapted to connect to a terminal of an adjacent battery core of the battery pack, to implement a series connection between the two adjacent battery cores in the battery pack; and
when receiving a cut-off signal, the cut-off apparatus cuts off the conductive connection member, to disconnect the two battery cores connected to the conductive connection member.

17. The vehicle according to claim 16, wherein the battery pack comprises a plurality of smart connection sheets, when conductive connection members of the plurality of smart connection sheets are cut off by cut-off apparatuses, a high-voltage circuit of the battery pack is divided into a plurality of sections of voltage division circuits, and a voltage of each section of voltage division circuit is below a safety voltage.

18. The vehicle according to claim 16, wherein the conductive connection member has a weakened area, and when receiving the cut-off signal, the cut-off apparatus cuts off the conductive connection member along the weakened area.

19. The vehicle according to claim 16, wherein the cut-off apparatus is configured to be electrically connected to a battery management system, and the battery management system sends the cut-off signal to the cut-off apparatus when determining, through detecting a voltage, current, or temperature change signal of the battery pack, that a safety accident occurs to the battery pack; and the safety accident comprises one or more of violent collision, thermal runaway, a short circuit, or overcharge.

20. The vehicle according to claim 16, wherein the cut-off apparatus comprises a driving apparatus and a punch, and when receiving the cut-off signal, the cut-off apparatus drives, through the driving apparatus, the punch to move toward the conductive connection member, to cut off the conductive connection member through the punch.
